(19) United States
(12) Patent Application Publication
(10) Pub. No.: US 2021/0385062 A1
(43) Pub. Date: Dec. 9, 2021

(54) CLOCK RECOVERY FOR POINT-TO-MULTI-POINT COMMUNICATION SYSTEMS

(71) Applicant: Infinera Corporation, San Jose, CA (US)

(72) Inventors: Christopher Fludger, Nuremberg (DE); Mohsen Tehrani, Ottawa (CA); Mehdi Karimi, Ottawa (CA); Scott Pringle, Woodlawn (CA); Sofia Amado, Nuremberg (DE); Sandy Thomson, Ottawa (CA)

(73) Assignee: Infinera Corporation, San Jose, CA (US)

(21) Appl. No.: 17/409,787

(22) Filed: Aug. 23, 2021

Related U.S. Application Data
(63) Continuation-in-part of application No. 16/578,081, filed on Sep. 20, 2019.
(60) Provisional application No. 63/068,438, filed on Aug. 21, 2020.
(60) Provisional application No. 62/836,354, filed on Apr. 19, 2019.

(51) Int. Cl. H04L 7/033; H04L 7/00

(52) U.S. Cl. CPC H04L 7/0331; H04L 7/0075; H04L 7/0025

(57) ABSTRACT

Consistent with the present disclosure independent phase and frequency clock recovery on each SC. Both leaf and hub perform digital clock recovery on each SC by increasing the Rx-ADC sampling rate by a few ppm (˜16 ppm), and using a delay compensating element, together with gapped clocks. The gaps and delay compensating elements are independent on each SC. The delay element is performed using the frequency domain DSP engine, where the frequency domain equalizer coefficients are modified with a delay compensating element Thus, each SC can have its own fine timing frequency and timing phase tuning, and fine tracking of its own jitter. When the delay compensating element, which, for example, may include a finite impulse response (FIR) filter, reaches the end of its range, a clock gap equal to an integer number of symbols is performed. The delay element can be reset by the same number of symbols providing continuous phase interpolation.

### BACKGROUND

The present patent application hereby claims priority to the provisional patent applications identified by U.S. Ser. No. 63/068,438 filed on Aug. 21, 2020, and U.S. Ser. No. 63/081,537 filed Sep. 24, 2020, the entire content of each of which is hereby incorporated by reference.

In digital communication systems, data to be transmitted may be encoded as a series of digital samples, whereby a group of such samples constitutes a symbol. The timing by which the digital samples are generated is controlled by a clock, such as a voltage controlled oscillator. The digital samples may be converted, by a digital-to-analog converter, to an analog signal which is then used to modulate light output from a laser, for example. At a receive end of the system, the optical signal may be converted to corresponding analog electrical signals and supplied to an analog to digital converter that outputs a series of samples. Due to transmission impairments, however, the digital samples generated in the receiver may have an associated clock or timing phase and frequency that is different than or offset relative to an internal clock used for processing data in the receiver.

Such phase and frequency offsets may be present in so-called point-to-multi-point communication systems, and, in particular, such systems that transmit optical subcarriers. Such point-to-multi-point optical subcarrier systems include a hub node and a plurality of leaf nodes. The hub node includes a transmitter that, in one example, broadcasts multiple optical subcarriers to each of a plurality of leaf nodes. At each leaf node, a receiver process and outputs data associated with the subcarriers corresponding to that node. Each leaf node may also include a transmitter that outputs one or more optical subcarriers to a receiver in the hub node.

Accordingly, the leaf receiver may demodulate several optical subcarriers, each of which originating from the hub node, and one clock recovery circuit may be sufficient to process the received optical subcarriers. However, the hub receiver can receive optical subcarriers from multiple leaf nodes provided in geographically diverse locations. Therefore, the data associated with each optical subcarrier can accumulate a different clock or timing phase error. In addition, thermal expansion of the fiber interconnecting the hub and leaf nodes can significantly contribute to such clock phase errors, albeit over long time periods. An efficient clock recovery circuit associated with each optical subcarrier is desired where both phase and frequency error may be compensated, but with reduced component costs and power dissipation.

### SUMMARY

Consistent with an aspect of the present disclosure, a point-to-multi-point clock recovery system is provided, where the leaf node is substantially locked in frequency to the hub node. Such locking may be close to 0 or at a fixed frequency offset and may be controlled by adjusting the leaf VCO frequency for the receiver and using the same VCO for the transmitter.

In addition, a point-to-multi-point system is provided where the optical subcarriers are converted to electrical signals, which are then digitized by analog to digital converter circuits to provide digital samples. Moreover, clock recovery is performed individually for optical subcarriers transmitted from different leaves. The clock recovery system includes an inner loop filter that detects and correct phase errors, an outer loop filter that detects and correct frequency errors, and phase interpolation is applied in the frequency domain on demultiplexed electrical signals, each of which being associated with an optical subcarrier. A phase ramp generating circuit provides a frequency offset and phase error compensation circuitry corrects for jitter. Clock gapping or data valid signals are used to allow the limited range phase interpolator to act in a continuous manner by causing jumps in the phase ramp.

Gain-sharing where symbols from a common FEC source are split across data associated with multiple optical subcarriers to average performance variations. Gap synchronization and frame-synchronization are performed to accommodate optical subcarriers that are recovered with separate clock recovery circuits.

It is to be understood that both the foregoing general description and the following detailed description are exemplary and explanatory only and are not restrictive of the invention, as claimed.

The accompanying drawings, which are incorporated in and constitute a part of this specification, illustrate one (several) embodiment(s) and together with the description, serve to explain the principles of the invention.

### BRIEF DESCRIPTION OF THE DRAWINGS

FIGS. 1 and 2 illustrate examples of a point-to-multi-point system consistent with the present disclosure;

FIG. 3 illustrate an example of a hub and leaf node consistent with the present disclosure;

FIG. 4 illustrates an example of a power spectral density plot consistent with the present disclosure;

FIG. 5 shows an example of a transmitter consistent with the present disclosure;

FIG. 6a illustrates an example of a receiver consistent with the present disclosure;

FIG. 6b shows an example of a laser that is shared between a transmitter and receiver consistent with a further aspect of the present disclosure;

FIG. 7 illustrates a detailed block diagram of a receiver DSP consistent with the present disclosure;

FIGS. 8a and 8b shows examples of actual and interpolated samples consistent with the present disclosure;

FIG. 9 shows an example of loop circuitry consistent with an aspect of the present disclosure;

FIGS. 10a-10c illustrates outputs of various circuits shown in FIG. 9;

FIG. 11 shows duplicated symbols as a result of clock gapping consistent with the present disclosure; and

FIG. 12 shows circuitry employed to facilitate gain sharing consistent with a further aspect of the present disclosure.

### DESCRIPTION OF THE EMBODIMENTS

Consistent with the present disclosure independent phase and frequency clock recovery on each SC. Both leaf and hub perform digital clock recovery on each SC by increasing the Rx-ADC sampling rate by a few ppm (˜16 ppm), and using a delay compensating element, together with gapped clocks. The gaps and delay compensating elements are independent on each SC. The delay element is performed using the frequency domain DSP engine, where the frequency domain equalizer coefficients are modified with a delay compensating element Thus, each SC can have its own fine timing frequency and timing phase tuning, and fine tracking of its own jitter. When the delay compensating element reaches the end of its range, a clock gap equal to an integer number of symbols is performed. The delay element can be reset by the same number of symbols providing continuous phase interpolation.

Reference will now be made in detail to the present embodiment(s) (exemplary embodiments) of the present disclosure, an example(s) of which is (are) illustrated in the accompanying drawings. Wherever possible, the same reference numbers will be used throughout the drawings to refer to the same or like parts.

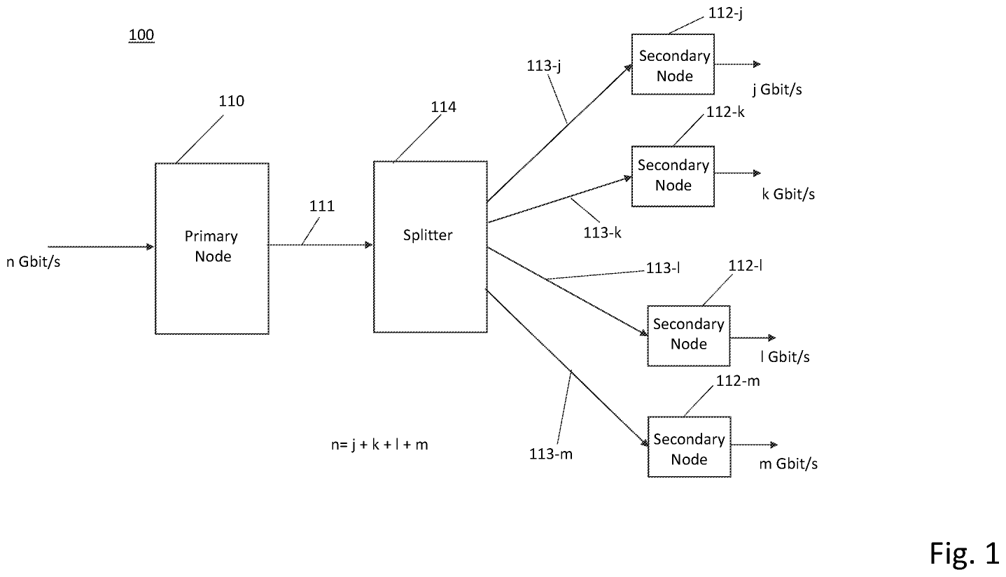

FIG. 1 illustrates an example of an aggregation network 100 consistent with the present disclosure in which primary node 110 may communicate with multiple secondary nodes 112-j to 112-m, which sometimes may be referred to individually or collectively as secondary node(s) 112. Secondary nodes 112, in one example, are remote from primary node 110. Primary node 110 may transmit optical subcarriers, described in greater detail below, in a downstream direction onto an optical communication path 111, which, like each of optical communication paths 113-j to 113-m, may include one or more segments of optical fiber, as well as one or more optical amplifiers, reconfigurable add-drop multiplexers (ROADMs) or other optical fiber communication equipment. Splitter 114 may be coupled to an end of optical communication path 111 to receive the optical subcarriers and provide a power split portion of each subcarrier to a corresponding one of secondary nodes 112-j to 112-m via a respective one of optical communication paths 113-j to 113-m.

As further shown in FIG. 1, primary node 110 has a data capacity to receive n Gbit/s of data (e.g., a data stream) for transmission to secondary node 112. Each secondary node 112 may receive and output to a user or customer a portion of the data input to primary node 110. In this example, secondary nodes 112-j, 112-k, 112-l, and 112-m output j Gbit/s, k Gbit/s, l Gbit/s, and m Gbit/s of data (data streams), respectively, whereby the sum of the j, k, l, and m may equal n (where j, k, l, m, and n are positive numbers).

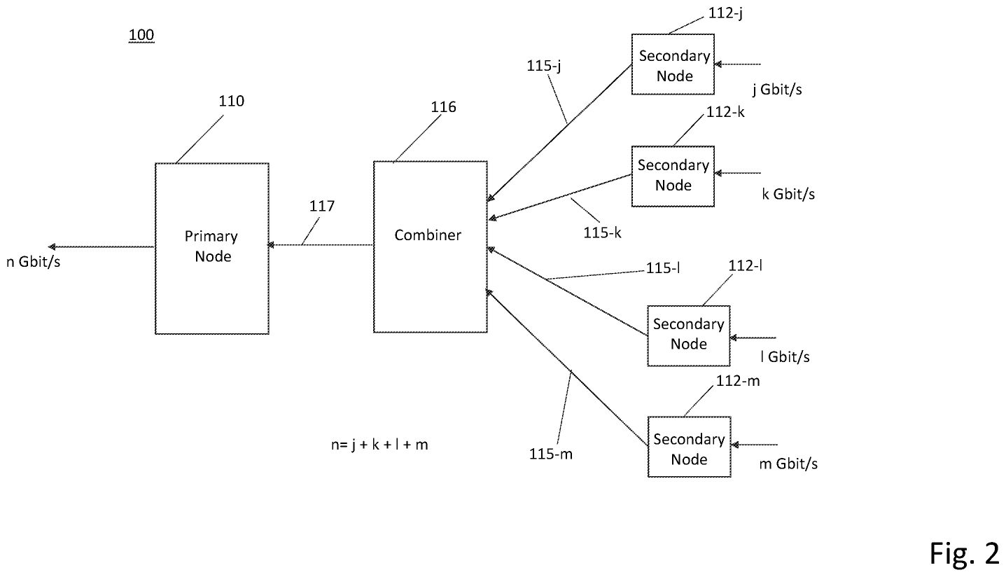

FIG. 2 show transmission of additional subcarriers in an upstream direction from secondary nodes 112-j to 112-m to primary node 110. As further shown in FIG. 2, each of secondary nodes 112-j to 112-m may transmit a corresponding group of subcarriers or one subcarrier to optical combiner 116 via a respective one of optical communication paths 115-1 to 115-m. Optical combiner 116 may, in turn, combine the received optical subcarriers from secondary nodes 112-j to 112-m onto optical communication path 117. Optical communication paths 115-1 to 115-m and 117 may have a similar construction as optical communication paths 111 and 112-1 to 112-m.

As further shown in FIG. 2, each of secondary nodes 112-j to 112-m receives a respective data stream having a corresponding data rate of j Gbit/s, k Gbit/s, l Gbit/s, and m Gbit/s. At primary node 110, data contained in these streams may be output such that the aggregate data supplied by primary node 110 is n Gbit/s, such that, as noted above, n may equal the sum of j, k, l, and m.

In another example, subcarriers may be transmitted in both an upstream and downstream direction over the same optical communication path. In particular, selected subcarriers may be transmitted in the downstream direction from primary node 110 to secondary nodes 112, and other subcarriers may be transmitted in the upstream direction from secondary nodes 112 to primary node 110.

In some implementations, network 100 may include additional primary and/or secondary nodes and optical communication paths, fewer primary and/or secondary nodes and optical communication paths or may have a configuration different from that described above. For example, network 100 may have a mesh configuration or a point-to-point configuration.

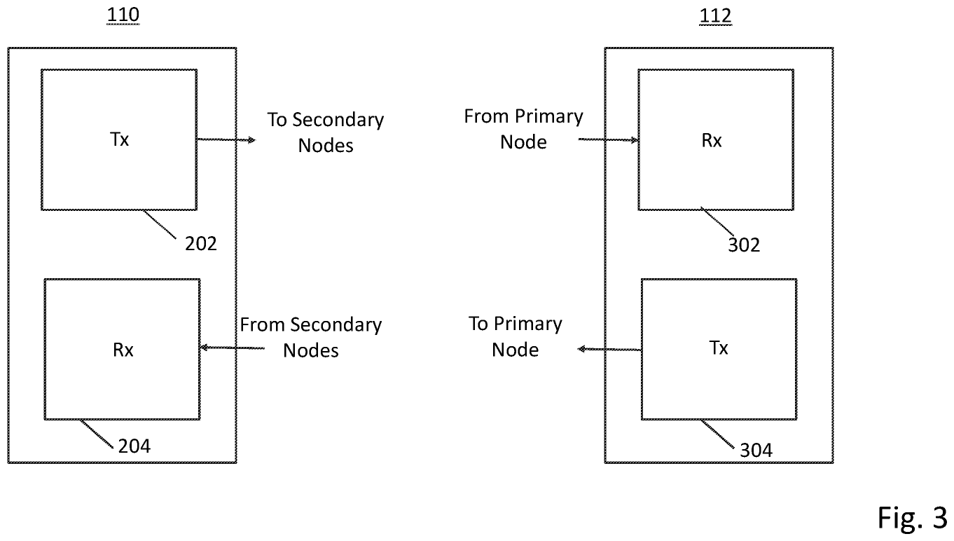

FIG. 3 illustrates primary node 110 in greater detail. Primary node 110 may include a transmitter 202 that supplies a downstream modulated optical signal including subcarriers, and a receiver that 204 that may receive upstream subcarriers carrying data originating from the secondary nodes, such as nodes 112-j to 112-m.

FIG. 3 further shows a block diagram of one of secondary nodes 112, which may include a receiver circuit 302 that receives one or more downstream transmitted subcarriers, and a transmitter circuit 304 that transmits one or more subcarriers in the upstream direction.

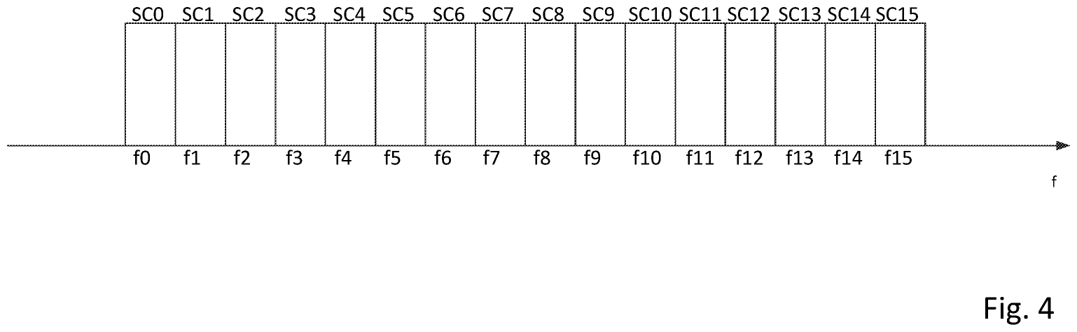

FIG. 4 illustrates an example of a transmission spectrum or power spectral density plot including sixteen (16) optical subcarriers (SC0 to SC15) that may be output from hub transmitter 202. Subcarriers SC0 to SC15, in one example, are Nyquist subcarriers, which are a group of optical signals, each carrying data, wherein (i) the spectrum of each such optical signal within the group is sufficiently non-overlapping such that the optical signals remain distinguishable from each other in the frequency domain, and (ii) such group of optical signals is generated by modulation of light from a single laser. In general, each subcarrier may have an optical spectral bandwidth that is at least equal to the Nyquist frequency, as determined by the baud rate of such subcarrier.

As noted above, each of secondary nodes 112 may include less expensive components than the components included in primary node 110. Accordingly, the bandwidth or the data capacity of the secondary nodes 112 may be less than that associated with primary node 110, such that the capacity associated with each secondary node 112 is less than that of primary node 110.

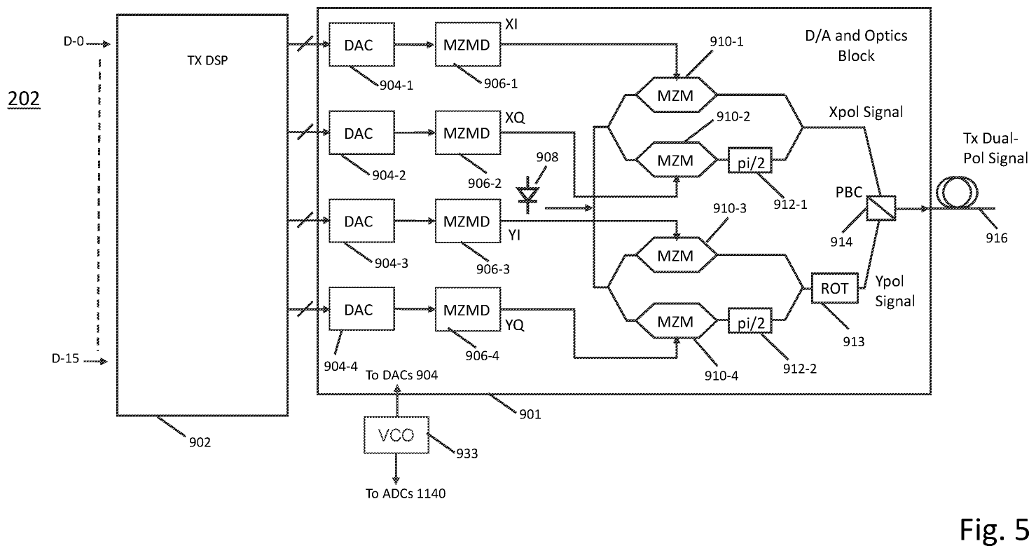

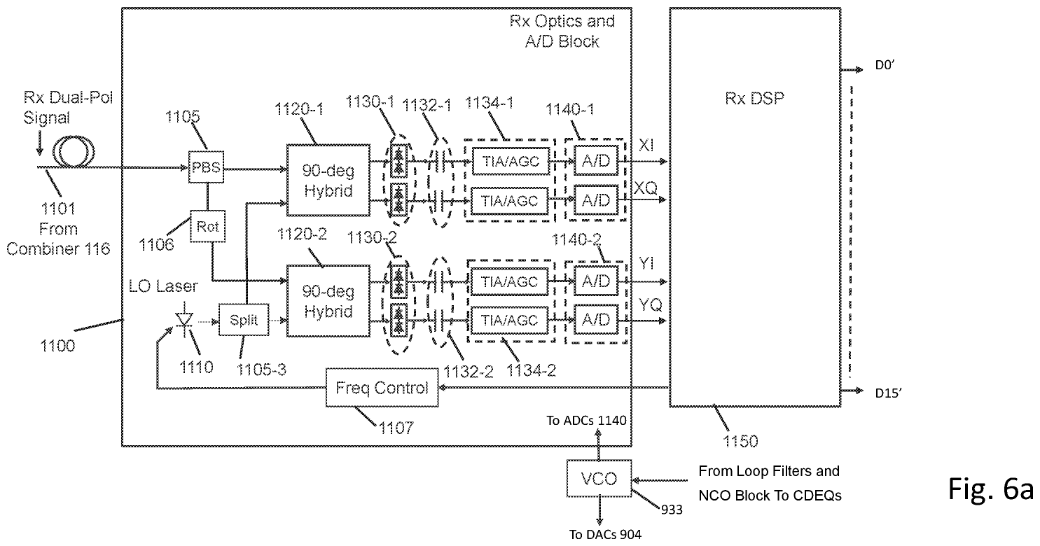

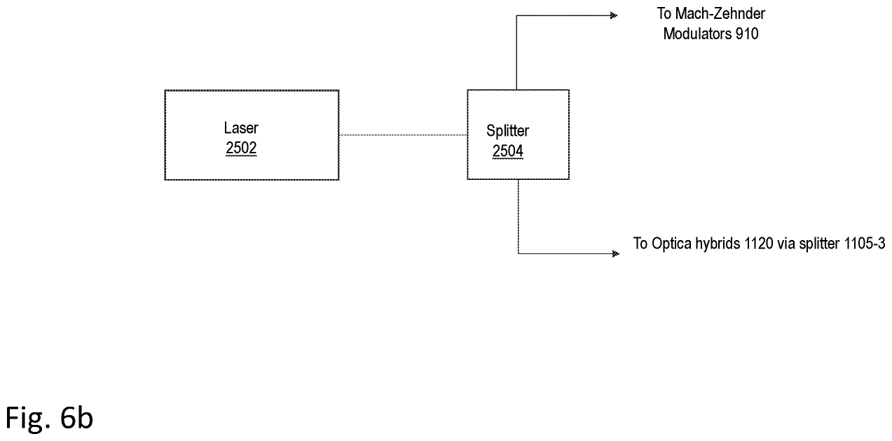

FIG. 5 illustrates transmitter 202 of primary node 110 in greater detail. Transmitter 202 includes a plurality of circuits or switches SW, as well as a transmitter DSP (TX DSP) 902 and a D/A and optics block 901. TX DSP 902, in this example, receives fifteen data streams D0 to D15. Based on these data streams, DSP 902 may supply a plurality of outputs to D/A and optics block 901 including digital-to-analog conversion (DAC) circuits 904-1 to 904-4, which convert digital signal received from DSP 902 into corresponding analog signals under the control of timing or clock signals output from a voltage controlled oscillator (VCO) 933. D/A and optics block 901 also includes driver circuits 906-1 to 906-2 that receive the analog signals from DACs 904-1 to 904-4 and adjust the voltages or other characteristics thereof to provide drive signals to a corresponding one of modulators 910-1 to 910-4. VCO 933 also provides timing or clock signals to ADCs provided in receiver 204, as described in greater detail below with respect to FIG. 6a.

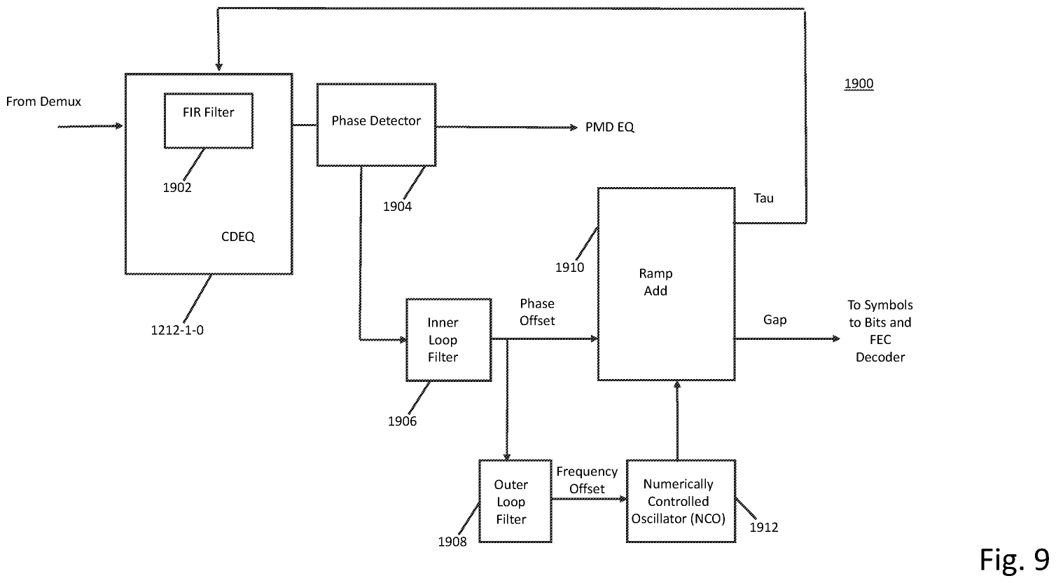

D/A and optics block 901 further includes modulators 910-1 to 910-4, each of which may be, for example, a Mach-Zehnder modulator (MZM) that modulates the phase and/or amplitude of the light output from laser 908. As further shown in FIG. 9, light output from laser 908, also included in block 901, is split such that a first portion of the light is supplied to a first MZM pairing, including MZMs 910-1 and 910-2, and a second portion of the light is supplied to a second MZM pairing, including MZMs 910-3 and 910-4. The first portion of the light is split further into third and fourth portions, such that the third portion is modulated by MZM 910-1 to provide an in-phase (I) component of an X (or TE) polarization component of a modulated optical signal, and the fourth portion is modulated by MZM 910-2 and fed to phase shifter 912-1 to shift the phase of such light by 90 degrees in order to provide a quadrature (Q) component of the X polarization component of the modulated optical signal. Similarly, the second portion of the light is further split into fifth and sixth portions, such that the fifth portion is modulated by MZM 910-3 to provide an I component of a Y (or TM) polarization component of the modulated optical signal, and the sixth portion is modulated by MZM 910-4 and fed to phase shifter 912-2 to shift the phase of such light by 90 degrees to provide a Q component of the Y polarization component of the modulated optical signal.

The optical outputs of MZMs 910-1 and 910-2 are combined to provide an X polarized optical signal including I and Q components and are fed to a polarization beam combiner (PBC) 914 provided in block 901. In addition, the outputs of MZMs 910-3 and 910-4 are combined to provide an optical signal that is fed to polarization rotator 913, further provided in block 901, that rotates the polarization of such optical signal to provide a modulated optical signal having a Y (or TM) polarization. The Y polarized modulated optical signal also is provided to PBC 914, which combines the X and Y polarized modulated optical signals to provide a polarization multiplexed (“dual-pol”) modulated optical signal onto optical fiber 916, for example, which may be included as a segment of optical fiber in optical communication path 111.

MZMs 910-1 to 910-4 may be referred to individually or in combination as a modulator.

The polarization multiplexed optical signal output from D/A and optics block 401 includes subcarriers SC0-SC15 noted above, such that each subcarrier has X and Y polarization components and I and Q components. Moreover, each subcarrier SC0 to SC15 may be associated with or corresponds to a respective one of data streams D0 to D15 input to DSP 902. Such optical subcarriers, as noted above, may be supplied to an optical splitter (see FIG. 1), which supplies a power split portion of each of the optical subcarriers, in one example, to a respective one of leaf nodes 112. As noted above with respect to FIG. 1, each of leaf recovers and outputs data designated for it.

As described above with respect to FIG. 2, each leaf also receives data and is operable to transmit information associated with such data on one or more subcarriers upstream to the primary 110. A combiner 116 combines the upstream optical subcarriers and supplies the optical subcarriers to primary node or hub 110. A receiver in hub node 110 will next be described with reference to FIG. 6a.

As shown in FIG. 6a, optical receiver 204 may include an Rx optics and ND block 1100, which, in conjunction with DSP 1150, may carry out coherent detection. Block 1100 may include a polarization splitter (PBS) 1105 with first (1105-1) and second (1105-2) outputs), a local oscillator (LO) laser 1110, 90 degree optical hybrids or mixers 1120-1 and 1120-2 (referred to generally as hybrid mixers 1120 and individually as hybrid mixer 1120), detectors 1130-1 and 1130-2 (referred to generally as detectors 1130 and individually as detector 1130, each including either a single photodiode or balanced photodiode), AC coupling capacitors 1132-1 and 1132-2, transimpedance amplifiers/automatic gain control circuits TIA/AGC 1134-1 and 1134-2, ADCs 1140-1 and 1140-2 (referred to generally as ADCs 1140 and individually as ADC 1140).

Polarization beam splitter (PBS) 1105 may include a polarization splitter that receives an input polarization multiplexed optical signal including optical subcarriers SC0 to SC19 supplied by optical fiber link 1101, which may be, for example, an optical fiber segment as part of one of optical communication paths 117 extending from combiner 116. PBS 1105 may split the incoming optical signal into the two X and Y orthogonal polarization components. The Y component may be supplied to a polarization rotator 1106 that rotates the polarization of the Y component to have the X polarization. Hybrid mixers 1120 may combine the X and rotated Y polarization components with light from local oscillator laser 1110, which, in one example, is a tunable laser. For example, hybrid mixer 1120-1 may combine a first polarization signal (e.g., the component of the incoming optical signal having a first or X (TE) polarization output from a first PBS port with light from local oscillator 1110, and hybrid mixer 1120-2 may combine the rotated polarization signal (e.g., the component of the incoming optical signal having a second or Y (TM) polarization output from a second PBS port) with the light from local oscillator 1110. In one example, polarization rotator 1190 may be provided at the PBS output to rotate Y component polarization to have the X polarization.

Detectors 1130 may detect mixing products output from the optical hybrids, to form corresponding voltage signals, which are subject to AC coupling by capacitors 1132-1 and 1132-1, as well as amplification and gain control by TIA/AGCs 1134-1 and 1134-2. The outputs of TIA/AGCs 1134-1 and 1134-2 and ADCs 1140 may convert the voltage signals to digital samples. For example, two detectors (e.g., photodiodes) 1130-1 may detect the X polarization signals to form the corresponding voltage signals, and a corresponding two ADCs 1140-1 may convert the voltage signals to digital samples for the first polarization signals after amplification, gain control and AC coupling. Similarly, two detectors 1130-2 may detect the rotated Y polarization signals to form the corresponding voltage signals, and a corresponding two ADCs 1140-2 may convert the voltage signals to digital samples for the second polarization signals after amplification, gain control and AC coupling. RX DSP 1150 may process the digital samples associated with the X and Y polarization components to output data associated with subcarriers SC0 to SC15

While FIG. 6a shows optical receiver 204 as including a particular number and arrangement of components, in some implementations, optical receiver 204 may include additional components, fewer components, different components, or differently arranged components. The number of detectors 1130 and/or ADCs 1140 may be selected to implement an optical receiver 204 that is capable of receiving a polarization multiplexed signal. In some instances, one of the components illustrated in FIG. 6a may carry out a function described herein as being carry out by another one of the components illustrated in FIG. 6a.

As further shown in FIG. 6a and as noted above, VCO 933 provides timing or clock signals for controlling ADCs 1140. In one example, each of ADCs 1140 provide a series of digital samples, the timing or rate of which is based on the clock output from VCO 933. In a similar fashion the clock supplied to DACs 904 from VCO 933 determines, in one example, the rate or timing of analog signals supplied to drivers 906.

In a further example, as shown in FIG. 6b, one laser 2502 may be provided that supplies light or an optical signal to a splitter 2504, which, in turn, provides a first portion of the optical signal to MZMs 910 and a second portion to optical hybrids 1120 via splitter 1105-3. Here, one laser 2502 is provided instead of first (908) laser in the transmitter and a second laser 1110 in the receiver.

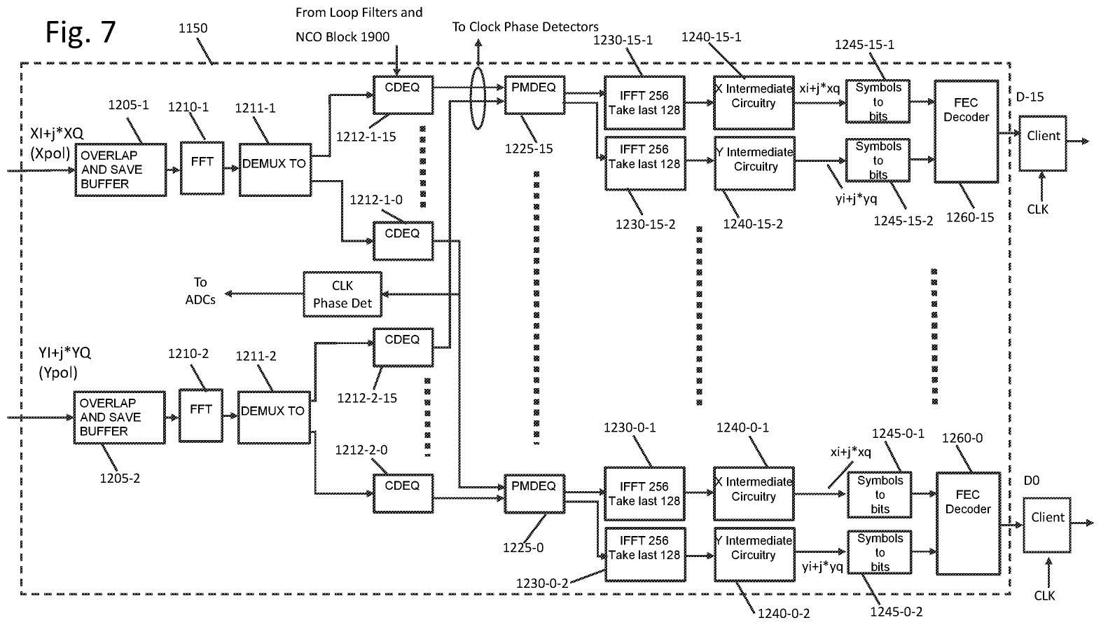

FIG. 7 illustrates exemplary components of receiver digital signal processor (DSP) 1150. As noted above, analog-to-digital (ND) circuits 1140-1 and 1140-2 (FIG. 6a) output digital samples corresponding to the analog inputs supplied thereto. In one example, the samples may be supplied by each A/D circuit at a rate of 64 GSamples/s. The digital samples correspond to symbols carried by the X polarization of the optical subcarriers and may be represented by the complex number XI+jXQ. The digital samples may be provided to overlap and save buffer 1205-1, as shown in FIG. 7. FFT component or circuit 1210-1 may receive the 2048 vector elements, for example, from the overlap and save buffer 1205-1 and convert the vector elements to the frequency domain using, for example, a fast Fourier transform (FFT). The FFT component 1210-1 may convert the 2048 vector elements to 2048 frequency components, each of which may be stored in a register or “bin” or other memory, as a result of carrying out the FFT.

The frequency components then may be demultiplexed by demultiplexer 1211-1, and groups of such components may be supplied to a respective one of chromatic dispersion equalizer circuits CDEQ 1212-1-0 to 1212-1-15, each of which may include a finite impulse response (FIR) filter that corrects, offsets or reduces the effects of, or errors associated with, chromatic dispersion of the transmitted optical subcarriers. Each of CDEQ circuits 1212-1-0 to 1212-1-15 supplies an output to a corresponding polarization mode dispersion (PMD) equalizer circuit 1225-0 to 1225-15 (which individually or collectively may be referred to as 1225). As described in greater detail below, the CDEQ associated with each optical subcarrier also provides an output to a clock phase detector and receives an output from circuitry 1900 described in greater detail below.

Digital samples output from ND circuits 640-2 associated with Y polarization components of subcarrier SC1 may be processed in a similar manner to that of digital samples output from ND circuits 1240-1 and associated with the X polarization component of each subcarrier. Namely, overlap and save buffer 1205-2, FFT 1210-2, demultiplexer 1211-2, and CDEQ circuits 1212-2-0 to 1212-2-15 may have a similar structure and operate in a similar fashion as buffer 1205-1, FFT 1210-1, demultiplexer 122-1, and CDEQ circuits 1212-1-0 to 1212-1-15, respectively. For example, each of CDEQ circuits 1212-2-0 to 1212-15 may include an FIR filter that corrects, offsets, or reduces the effects of, or errors associated with, chromatic dispersion of the transmitted optical subcarriers. In addition, each of CDEQ circuits 1212-2-0 to 1212-2-15 provide an output to a corresponding one of PMDEQ 1225-0 to 1225-15. Loop circuitry similar to that described below may also provide outputs to CDEQ circuits 1212. The outputs of the CDEQ circuits are also provided to clock phase detectors similar to those also described below.

As further shown in FIG. 7, the output of one of the CDEQ circuits, such as CDEQ 1212-1-0 may be supplied to clock phase detector circuit 1213 to determine a clock phase or clock timing associated with the received subcarriers. Such phase or timing information or data may be supplied to ADCs 1140-1 and 1140-2 to adjust or control the timing of the digital samples output from ADCs 1140-1 and 1140-2.

Each of PMDEQ circuits 1225 may include another FIR filter that corrects, offsets or reduces the effects of, or errors associated with, PMD of the transmitted optical subcarriers. Each of PMDEQ circuits 1225 may supply a first output to a respective one of IFFT components or circuits 1230-0-1 to 1230-15-1 and a second output to a respective one of IFFT components or circuits 1230-0-2 to 1230-15-2, each of which may convert a 256-element vector, in this example, back to the time domain as 256 samples in accordance with, for example, an inverse fast Fourier transform (IFFT).

Time domain signals or data output from IFFT 1230-0-1 to 1230-15-1 are supplied to a corresponding one of Xpol intermediate circuits 1240-1-1 to 1240-15-1, which carry out further processing of the X pol time domain data. In a similar manner, time domain signals or data output from IFFT 1230-0-2 to 1230-15-2 are supplied to a corresponding one of Ypol intermediate circuits1240-0-2 to 1240-15-2 that carry out further processing of the Y pol time domain data.

Each of the symbols-to-bits circuits or components 1245-0-1 to 1245-15-1 may receive the symbols output from a corresponding one of circuits 1240-0-1 to 1240-15-1 and map the symbols back to bits. For example, each of the symbol-to-bits components 1245-0-1 to 1245-15-1 may map one X polarization symbol, in a QPSK or m-QAM constellation, to Z bits, where Z is an integer. For dual-polarization QPSK modulated subcarriers, Z is four. Bits output from each of component 1245-0-1 to 1245-15-1 are provided to a corresponding one of FEC decoder circuits 1260-0 to 1260-15.

Y polarization symbols are output form a respective one of circuits 1240-0-2 to 1240-15-2, each of which has the complex representation yi+j*yq associated with data carried by the Y polarization component. Each Y polarization, like the X polarization symbols noted above, may be provided to a corresponding one of bit-to-symbol circuits or components 1245-0-2 to 1245-15-2, each of which has a similar structure and operates in a similar manner as symbols-to-bits component 1245-0-1 to 1245-15-1. Each of circuits 1245-0-2 to 1245-15-2 may provide an output to a corresponding one of FEC decoder circuits 1260-0 to 1260-15.

Each of FEC decoder circuits 1260 may remove errors in the outputs of symbol-to-bit circuits 1245 using, for example, forward error correction. Such error corrected bits, which may include user data for output from secondary node 112, may be supplied to a corresponding one of outputs provide data D0′ to D015′,

While FIG. 7 shows DSP 1150 as including a particular number and arrangement of functional components, in some implementations, DSP 650 may include additional functional components, fewer functional components, different functional components, or differently arranged functional components.

Preferably, each of the leaf nodes includes transmitters and receivers similar to the hub transmitter and receiver described above. Such leaf transmitters and receivers operate in a similar fashion as the hub transmitter and receiver. In operation, the circuitry described above, as provided in the leaf nodes 112 may, through clock recovery further described above, determine a timing associated with VCO 933 in hub 110 detect a timing of data carried by the downstream optical subcarriers from hub 110. As noted above, such timing is based on the clock signal output from VCO 933 in hub node 110. Such timing information may be provided to a VCO in the leaf node 112 to control the timing of the ADCs and DACs in the leaf nodes. Thus, the timing information or clock generated by VCO 933 in the hub may be used in the leaf nodes to control the timing of upstream optical subcarriers to receiver 204 in hub 110. As further noted above, the timing of the ADC sampling in hub 110 is also based on the clock output from VCO 933, each of the VCO clocks in the leaf and hub nodes may be the same under stable thermal conditions, for example. In another example, the VCO clock frequency in the leaf nodes may be offset from the frequency of the VCO clock in the hub.

Typically, however, due to temperature changes in the fibers 115 and 117 (see FIG. 2) connecting the hub and leaf nodes the distance traveled by the optical subcarriers may differ over time. For example, if the fibers expand due to elevated temperatures in the surrounding environment, the distances traveled by the optical subcarriers may be greater than if the surrounding environment is at a cooler temperature. Moreover, the leaf nodes 112 are typically provided in geographically diverse locations. Accordingly, the temperature variations experienced by fibers traversed by optical subcarriers output from one leaf node 112 may differ from the temperature variations experienced by fibers traversed by optical subcarriers output from another leaf node 112. As a result, the data carried by one optical subcarrier may have a different delay or phase relative to the data carried by another optical subcarrier. Errors may also occur in each VCO, thereby further adding to such phase error.

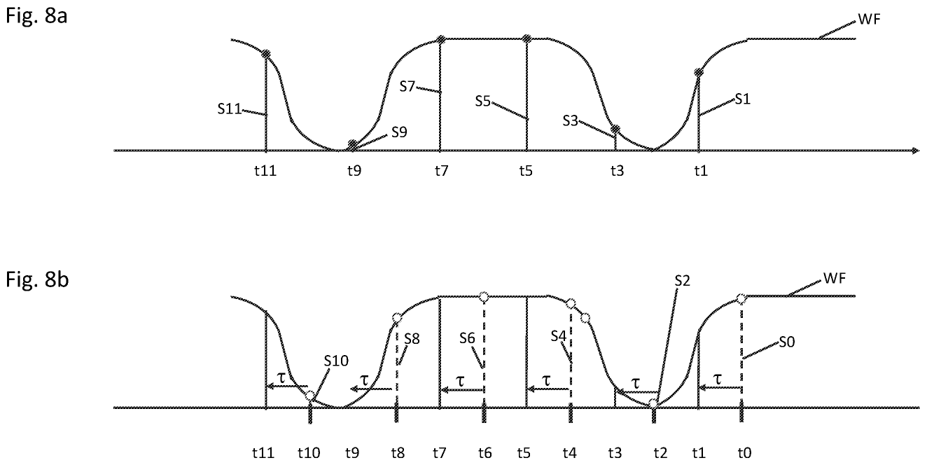

For example, as shown in FIG. 8a, an electrical signal associated with an X polarization of an optical subcarrier may have a waveform WF. As described above, the waveform WF is sampled by ADC circuits 1140-1 and 140-2 to provide digital samples S1, S3, S5, S7, S9, and S11 at times t1, t3, t5, t7, t9, and t11, respectively. As shown in FIG. 8b, however, such sample, are offset or phase delayed relative to desired samples S1′ to S6′, which are timed to align with symbol periods and clocks associated with RX DSP 1150 to carry out carrier recovery, as well as clock and data recovery, and other processing. The delay is represented in FIG. 8b by “tau” and the arrows associated therewith in the figure. Since there is no sampled data at the desired temporal locations or times, e.g., times t0, t2, t4, t6, t8, and t10, the data S0, S2, S4, S6, S8, and S10 at such respective temporal locations or times may be interpolated, in one example.

In one example, a finite impulse response (FIR) filter 1902 in the CDEQ circuits is provided to supply the interpolated data or samples, where the tap weights associated with FIR filter 1902 are determined based on tau. In one example, the tap weights are based on an exp(−j.tau) function. Loop circuitry or carrier recovery circuitry 1900 may be employed to determine tau, as described in greater detail below with respect to FIG. 9.

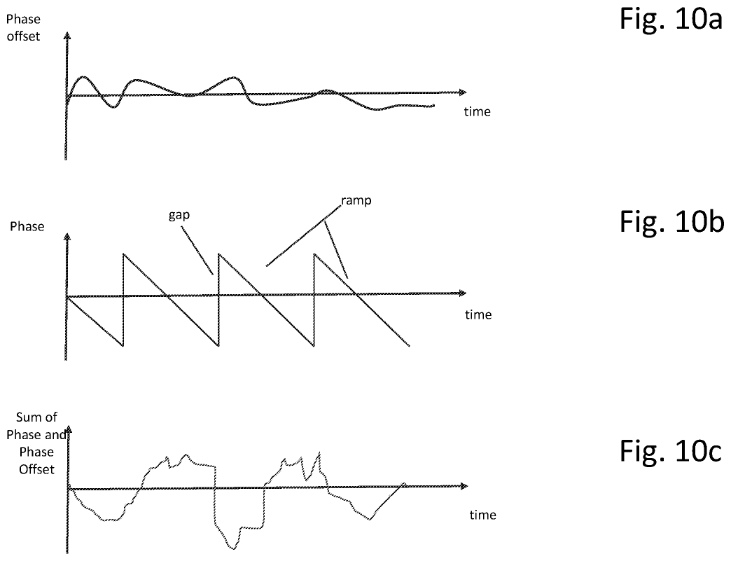

As shown in FIG. 9, a phase detector 1904 is provided to detect an amount of phase delay associated with the data samples or received data signals. The detected phase information is provided an inner loop filter circuit 1906 that provides a first control signal indicative of an amount of phase error or phase offset. In one example, includes an infinite impulse response (IIR) filter. In a further example, the output of inner loop circuit 1906 is associated with an amount of jitter in the data signals. FIG. 10a is an example of an output of circuit 1906 as a function of time.

The output of circuit 1906 is fed to an adder circuit 1910 as well as to an outer loop filter 1908, which provides a frequency offset or frequency error relative to the VCO clock frequency based on the output of circuit 1906. Typically, the frequency offset is in parts per million. The phase can change over time if there is a frequency offset or difference between the frequency associated with the incoming data signal and the VCO. Depending on the amount of the offset, which may be on the order of 40,000 symbols for a 40 degree change in temperature over 4000 km of fiber. Typically, it is impractical to store such large phase values in a buffer.

Accordingly, consistent with an aspect of the present disclosure, a small buffer is provided, but the amount of phase is periodically reset by providing clock gapping whereby based on an output of the numerically controlled oscillator (NCO) 1912, a phase ramp (see FIG. 10b) and gap signal is created. The phase ramp limits the phase to within a predetermined number of symbols. As further shown in FIG. 10b, a gap periodically increases the phase so that the phase does not decrease to very large negative values that are impractical to store and process.

The output of NCO 1912is provided to adder circuit 1910, which adds the phase offset value provided by inner loop filter 1906 to the phase ramp. An example of the resulting sum is shown in FIG. 10c. This sum corresponds to the tau value, which may vary over time and, therefore, the tap weights applied to the FIR filter 1902 also vary in a corresponding manner to provide updated interpolated samples with changing phase or timing delay.

In addition, a gap signal associated with each gap in FIG. 10b is output from adder 1910. The gap signal may be applied to selected circuits of DSP 1150 to temporarily pause or stop processing by such circuits. For example, the gap signal may be applied to symbols to bits demapper circuits 1245 and forward error correction decoder circuits 1260. The result of such temporary inactivity is that certain symbols present on certain DSP buses are duplicated and discarded, thereby realizing the gap and phase resetting discussed above.

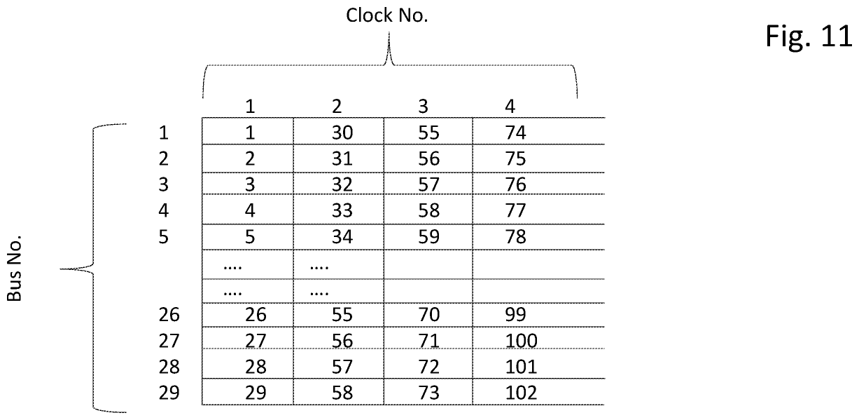

For example, as shown in FIG. 11, during clock cycle 2, buses 26-29 carry symbols 55-58, respectively. As a result of clock gapping, these symbols are duplicated on buses 1-4, respectively, during clock cycle 3.

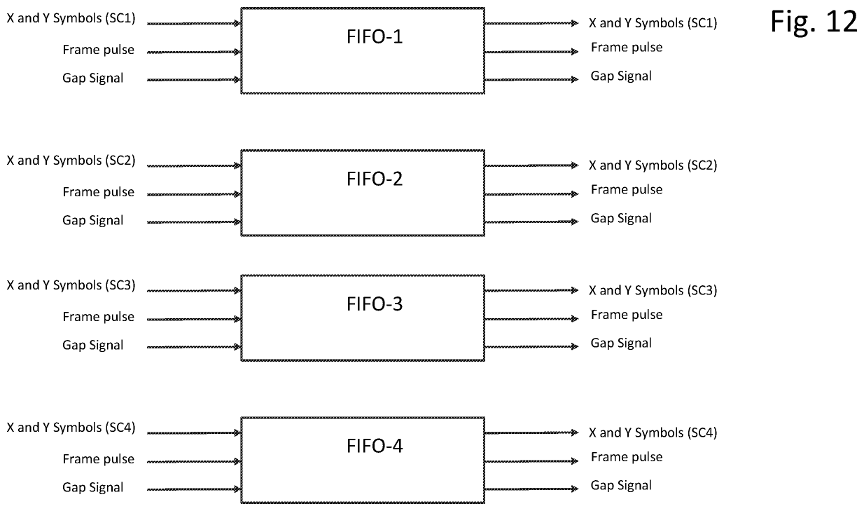

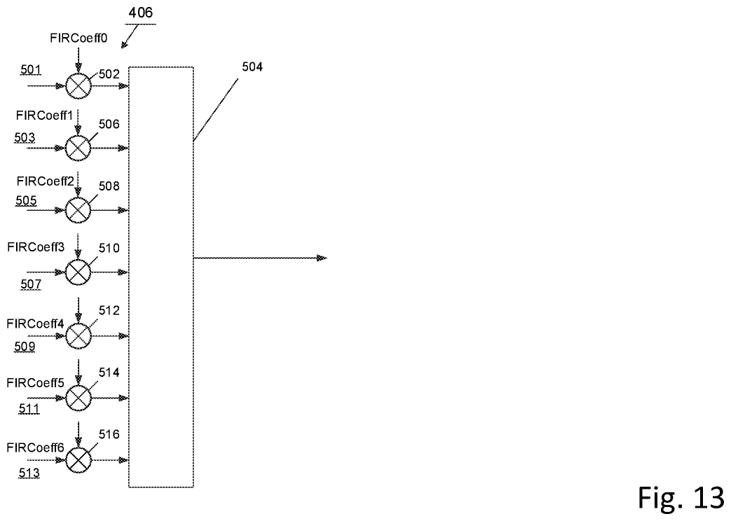

FIG. 12 illustrate a further application of the gap signal described above wherein the gap signal is employed to realize forward error correction gain sharing. Gain-sharing is where symbols from a common FEC source are split across data associated with multiple optical subcarriers, such as subcarriers SC0 to SC15. For leaf nodes that receive/process and transmit more than one optical subcarrier, this allows performance variation to be averaged, and the worse performing optical subcarriers, such as outer subcarriers, such as subcarriers SC0 and SC15, share FEC encoding with data associated with optical subcarriers having fewer transmission impairments and a higher bit error rate, such as optical subcarriers SC6 and SC8. When gain-sharing is used, the gap signal associated with each optical subcarrier is preferably first aligned to the gap signal of a designated optical subcarrier for gain sharing timing purposes. This alignment process is performed as part of the gain-sharing module. Gap synchronization is first performed and then the data is aligned using a frame-alignment header. Symbols may then be redistributed among the data associated with each optical subcarrier. In the example shown in FIG. 12, have gap signals synchronized to a common gapped master clock using a series of first in first out (FIFO) buffers FIFO-1 to FIFO-4.

As further shown in FIG. 12, FIFO-1 receives X and Y symbols associated with subcarrier SC1, as well as a frame pulse ang gap signal, both of which are output from FIFO-1 and well as symbols that are interleaved based on timing of the gap signal and the header. FIFO-2 receives X and Y symbols associated with subcarrier SC2, as well as a frame pulse ang gap signal, both of which are output from FIFO-2 and well as symbols that are interleaved based on timing of the gap signal and the header. In addition, FIFO-3 receives X and Y symbols associated with subcarrier SC3, as well as a frame pulse ang gap signal, both of which are output from FIFO-3 and well as symbols that are interleaved based on timing of the gap signal and the header. Moreover, FIFO-4 receives X and Y symbols associated with subcarrier SC4, as well as a frame pulse ang gap signal, both of which are output from FIFO-4 and well as symbols that are interleaved based on timing of the gap signal and the header.

It is noted that X and Y CDEQ circuits are provided for each optical subcarrier. Moreover, phase detector and loop circuit 1900 are provided for and is associated with each of X and Y polarizations of each optical subcarrier supplied from a leaf node to the hub. Thus, clock and data recovery is carried out, in one example, independently for each subcarrier, such that phase correction is similarly carried out independently on data or information associated with each optical subcarrier.

An example of the FIR filter 1902 is shown in FIG. 13. FIR filter or filter circuit 1902, in this example, has seven inputs or taps 501, 503, 505, 507, 509, 511, and 513 that receive data samples. The FIR filter 1902 also includes multipliers 502, 506, 508, 510, 512, 514, and 516, filter coefficients FIRCoeff0, FIRCoeff1, FIRCoeff2, FIRCoeff3, FIRCoeff4, FIRCoeff5 and FIRCoeff6, and block 504. As noted above, these coefficients are based on the tau value or tau function and may change over time.

Data associated with the data samples is supplied to a corresponding input or tap 501, 503, 505, 507, 509, 511, and 513 of FIR filter 1902 and to a corresponding multiplier 502, 506, 508, 510, 512, 514, and 516. which multiplies the corresponding output sample data by the corresponding coefficient FIRCoeff0, FIRCoeff1, FIRCoeff2, FIRCoeff3, FIRCoeff4, FIRCoeff5, and FIRCoeff6. The resulting products are then summed in block 504 to yield the output of the FIR filter 1902.

Other embodiments will be apparent to those skilled in the art from consideration of the specification. It is intended that the specification and examples be considered as exemplary only, with a true scope and spirit of the invention being indicated by the following claims.

What is claimed is:

1. An optical communication system, comprising:
a plurality of leaf nodes, each of which being operable to supply a respective one of a plurality of optical subcarrier, each of the plurality of leaf nodes including a corresponding one of a first plurality of voltage controlled oscillators, each of the first plurality of voltage controlled oscillators supplying a corresponding one of a first plurality of clock signals;
a hub node operable to receive each of the plurality of optical subcarriers, the hub node including a second voltage controlled oscillator that supplies a second clock signal, wherein a frequency of each of the first plurality of clock signals is based on a frequency of the second clock signal.

2. An optical receiver, comprising:
a plurality of clock recovery circuits, each of which being associated with a corresponding one of a plurality of optical subcarriers, each of the plurality of optical subcarriers being transmitted from a corresponding one of a plurality of leaf nodes, each of the plurality of clock recovery circuits including:
an inner loop filter operable to output phase error data associated with data carried by each of the plurality of optical subcarriers relative to a clock signal;
an outer loop filter operable to provide frequency error data based on the phase error data;
a numerically controlled oscillator operable to provide a phase ramp signal based on frequency error data; and
an interpolator circuit operable to provide interpolated samples based the phase error data and the phase ramp signal.
